(19) United States
(12) Patent Application Publication
(10) Pub. No.: US 2025/0334598 A1
(43) Pub. Date: Oct. 30, 2025

(54) METHODS AND SYSTEMS FOR AUTOMATIC SINGLE-CELL AND SPACIAL MULTI-OMICS PROFILING

(71) Applicant: Hongtao GU, Stouffville (CA)

(72) Inventor: Hongtao GU, Stouffville (CA)

(21) Appl. No.: 19/186,887

(22) Filed: Apr. 23, 2025

Related U.S. Application Data
(60) Provisional application No. 63/638,205, filed on Apr. 24, 2024.

(51) Int. Cl. G01N 35/00; G01N 1/36; G01N 35/04; G01N 35/10

(52) U.S. Cl. CPC G01N 35/00029; G01N 1/36; G01N 35/00584; G01N 35/1002; G01N 2035/00108; G01N 2035/00188; G01N 2035/00425; G01N 2035/00445; G01N 2035/0474

(57) ABSTRACT

Methods and systems for automatic spatial and single-cell multi-omics sample preparation and analysis. In examples, a continuous flexible sample strip is dispensed from a strip dispenser assembly, via a rotary mechanism. A prepared biological sample may be mounted to a sample receiving surface of the flexible sample strip to generate a continuous length of prepared sample strip and spatial and single-cell multi-omics data corresponding to the mounted biological sample may be generated based on the continuous length of prepared sample strip. In some embodiments, the methods and systems may be directed to preparing and analyzing a solid phase biological sample, such as an OCT embedded frozen tissue block or a FFPE tissue block. In other embodiments, the methods and systems may be directed to preparing and analyzing a liquid phase biological sample.

### CROSS-REFERENCES TO RELATED APPLICATIONS

This application claims the benefit of U.S. Provisional Patent Application No. 63/638,205, filed Apr. 24, 2024, Hongtao GU, titled METHODS AND SYSTEMS FOR AUTOMATIC SINGLE-CELL AND SPACIAL MULTI-OMICS PROFILING

### TECHNICAL FIELD

Example embodiments relate generally to the preparation and analysis of biological samples.

### BACKGROUND

Spatial and Single-cell multi-omics has emerged as an important tool for the analysis of a biological sample. The combined analysis of the genome, epigenome, transcriptome, proteome metabolome and/or glycome (multi-omics) from single cells is transforming our understanding of cell and molecular biology in health and disease. In particular, the simultaneous spatial analysis of both tissue structure and molecular characteristics of a tissue sample is beneficial for pathological applications.

In some cases, a biological sample within its originating tissue location can be a section of a solid phase tissue sample, such as a section of an OCT embedded frozen or formalin-fixed paraffin embedded (FFPE) tissue block. Solid phase tissue sections are obtained using a microtome or a cryotome and mounted on to individual glass slides for analysis. In other cases, a biological sample can be a liquid phase tissue sample, which is smeared and mounted on to individual glass slides for analysis. In some cases, the use of individual glass slides for mounting and analysis of biological samples limits the throughput of sample sectioning and smearing preparation as well as molecular omics analysis, therefore hindering the speed and automation of pathological and disease biomarker discovery.

Accordingly, it would be useful to provide an automatic solution for spatial and single-cell multi-omics sample preparation and analysis.

### SUMMARY

In various examples, example embodiments include methods and systems for the automatic preparation and analysis of a biological sample using spatial and single-cell multi-omics methods. In examples, a continuous flexible sample strip is dispensed from a strip dispenser assembly, via a rotary mechanism. A prepared biological sample may be mounted to a sample receiving surface of the flexible sample strip to generate a continuous length of prepared sample strip and multi-omics data corresponding to the mounted biological sample may be generated based on the continuous length of prepared sample strip. In some embodiments, the methods and systems may be directed to preparing and analyzing a solid phase biological sample, such as an OCT embedded frozen tissue block or a FFPE tissue block. In other embodiments, the methods and systems may be directed to preparing and analyzing a liquid phase biological sample, for example a liquid biopsy directly from a patient or a single-cell suspension from a solid tissue digestion.

In some example aspects, example embodiments include a system for automatic spatial and single-cell multi-omics sample preparation and analysis. The system includes: a dispensing assembly for dispensing a continuous flexible sample strip via a rotary mechanism; a sample preparation assembly for mounting a prepared biological sample to a sample receiving surface of the flexible sample strip to generate a continuous length of prepared sample strip; and a sample analysis assembly for generating spatial and single-cell multi-omics data corresponding to the mounted biological sample, based on the continuous length of prepared sample strip.

In some example aspects, example embodiments include a method. The method includes: dispensing a continuous flexible sample strip via a rotary mechanism; mounting a prepared biological sample to a sample receiving surface of the flexible sample strip to generate a continuous length of prepared sample strip; and generating spatial and single-cell multi-omics data corresponding to the mounted biological sample, based on the continuous length of prepared sample strip.

In another example aspect, the present disclosure describes a computer readable medium having instructions encoded thereon, wherein the instructions, when executed by a processor of a system, cause the system to perform any of the preceding example aspects of the method.

### BRIEF DESCRIPTION OF THE DRAWINGS

Reference will now be made, by way of example, to the accompanying drawings which show example embodiments, and in which:

FIG. 1 is a block diagram illustrating an example automatic spatial and single-cell multi-omics sample preparation and analysis system in which examples may be implemented;

FIG. 2 is a block diagram illustrating an example hardware structure of a computing system that is suitable for implementing example embodiments;

FIG. 3 is an example top view of a portion of the sample mounting strip, in accordance with example embodiments;

FIG. 4 is a schematic side view of an example strip dispenser assembly, in accordance with example embodiments;

FIG. 5 is a schematic side view of an example embodiment of the automatic spatial and single-cell multi-omics sample preparation and analysis system that is configured for preparing and analyzing a solid phase biological sample;

FIG. 6 is a schematic side view of an example embodiment of the solid phase assembly in a pre-installed state, in cooperation with the strip dispenser assembly;

FIG. 7A is a schematic top view of an example cylindrical specimen mold, in accordance with example embodiments;

FIG. 7B is an example a solid phase biological sample, in accordance with example embodiments;

FIG. 8 is a schematic side view of an example solid phase sample sectioning assembly, in accordance with example embodiments;

FIG. 9 is an example top view of a portion of the prepared solid phase sample strip, in accordance with an example embodiment;

FIG. 10 is a schematic side view of an example embodiment of the sample analysis assembly;

FIG. 11 is a schematic side view of an example embodiment of the automatic spatial and single-cell multi-omics sample preparation and analysis system that is configured for preparing and analyzing a liquid phase biological sample;

FIG. 12 is a schematic side view of an example embodiment of the liquid phase sample smearing assembly;

FIG. 13 is an example top view of an example embodiment of the sample mounting strip;

FIG. 14 is a flowchart illustrating an example method for automatic spatial and single-cell multi-omics sample preparation and analysis, when the sample is a solid phase biological sample; and

FIG. 15. Is a flowchart illustrating an example method for automatic spatial and single-cell multi-omics sample preparation and analysis, when the sample is a liquid phase biological sample.

Similar reference numerals may have been used in different figures to denote similar components.

### DETAILED DESCRIPTION

Reference is made to the following example technical solutions of example embodiments with reference to the accompanying drawings.

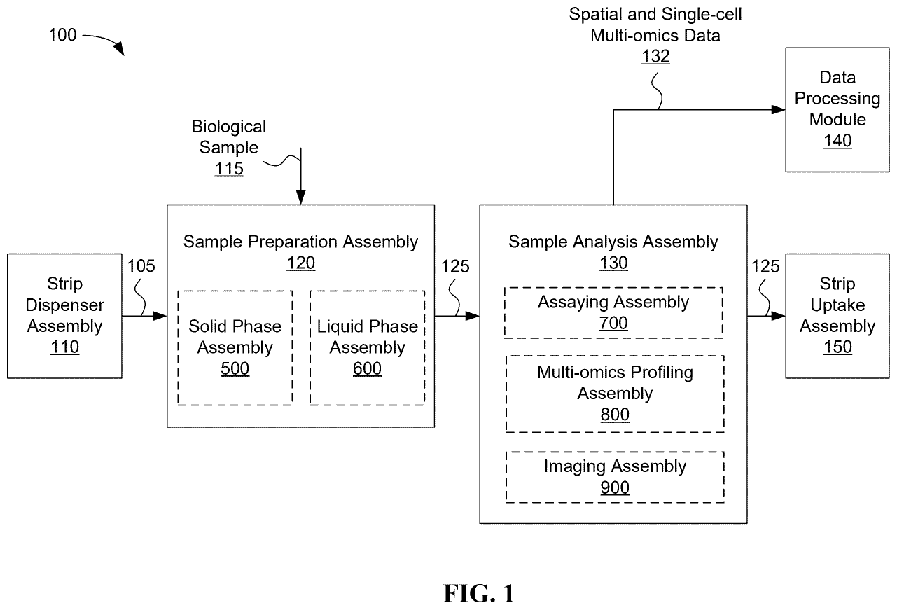

FIG. 1 is a block diagram illustrating an example automatic spatial and single-cell multi-omics sample preparation and analysis system 100 in which example embodiments may be implemented. The system 100 has been simplified in this example for ease of understanding; generally, there may be more entities and components in the system 100 than that shown in FIG. 1.

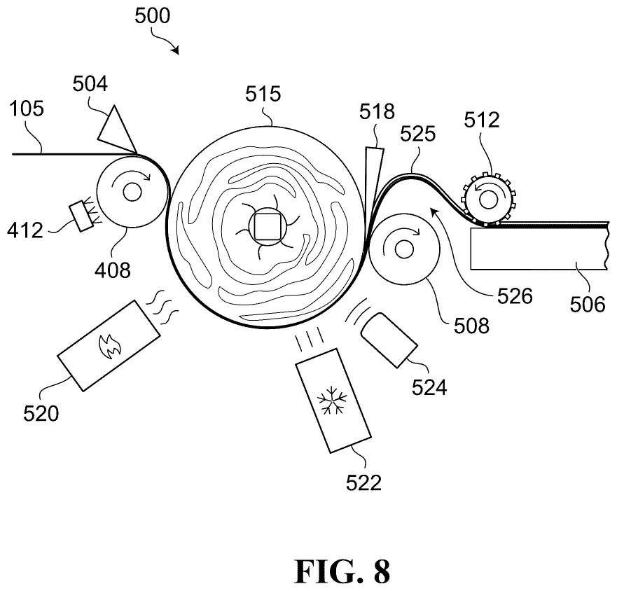

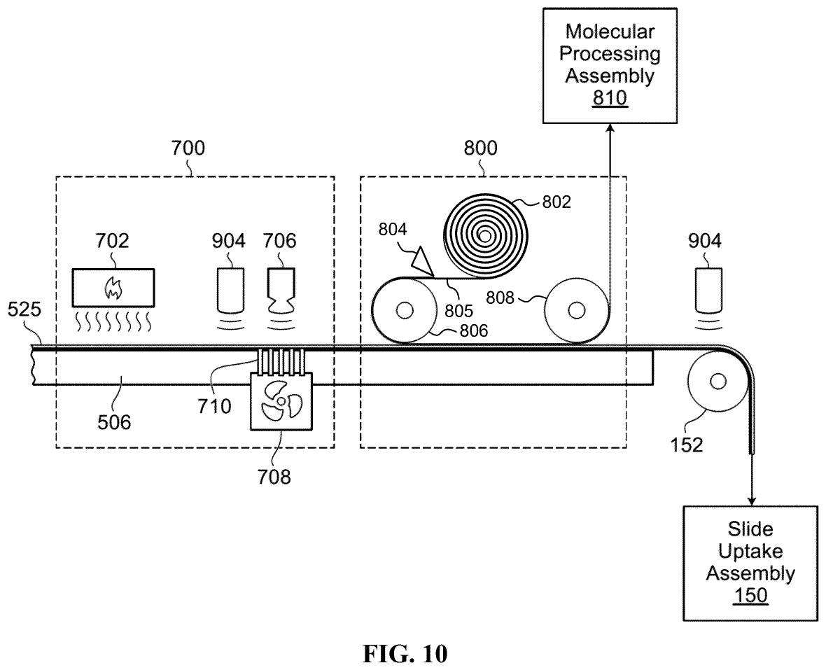

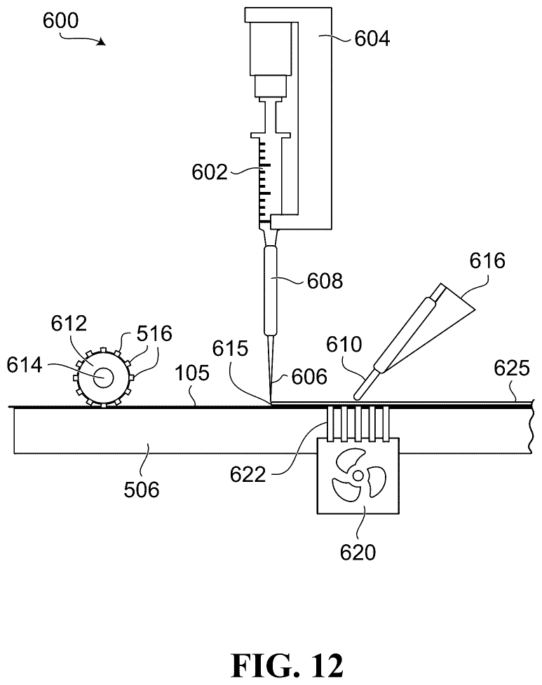

In exemplary embodiments, for example, the spatial and single-cell multi-omics sample preparation and analysis system 100 may include a strip dispenser assembly 110, a sample preparation assembly 120, a sample analysis assembly 130, a data processing module 140 and a strip uptake assembly 150, among others. In examples, the strip dispenser assembly 110 may enable the dispensing of a continuous length of a sample mounting strip 105 into the spatial and single-cell multi-omics sample preparation and analysis system 100 as described with respect to FIG. 4. In examples, the sample mounting strip 105 may be received by the sample preparation assembly 120 where a biological sample 115 may be prepared (e.g., sectioned or smeared) and fixed onto a surface of the sample mounting strip 105, as described with respect to FIG. 8 and FIG. 12. In some embodiments, for example, the biological sample 115 may be a solid phase biological sample, in which case the sample preparation assembly 120 may include an optional solid phase assembly 500 for preparing (e.g., sectioning) and fixing the prepared biological sample to the sample mounting strip 105. In some embodiments, for example, the biological sample 115 may be a liquid phase biological sample, in which case the sample preparation assembly 120 may include an optional liquid phase assembly 600 for preparing (e.g., smearing) and fixing the prepared biological sample to the sample mounting strip 105. In examples, the sample mounting strip 105 having the biological sample 115 fixed thereon may collectively be referred to as a prepared sample strip 125 and the prepared sample strip 125 may be received by the sample analysis assembly 130 where the biological sample 115 may be analyzed, for example, in cooperation with the data processing module 140, as described with respect to FIG. 10. In some embodiments, for example, the analyzing of the prepared biological sample may involve one or more pre-multi-omics profiling section or smear treatment assaying methods such as excessive OCT or paraffin wax cleaning, fixation, tissue clearing, pre-staining treatment, or imaging methods such as fluorescent imaging and/or bright field imaging, in which case the sample analysis assembly 130 may include an optional imaging assembly 900 or an optional assaying assembly 700. In some embodiments, for example, the analyzing of the prepared biological sample may involve one or more profiling methods, in which case the sample analysis assembly 130 may include optional one or more Multi-omics profiling assemblies 800. In examples, the prepared sample strip 125, having undergone one or more analysis procedures may be received by the strip uptake assembly 150 for storage.

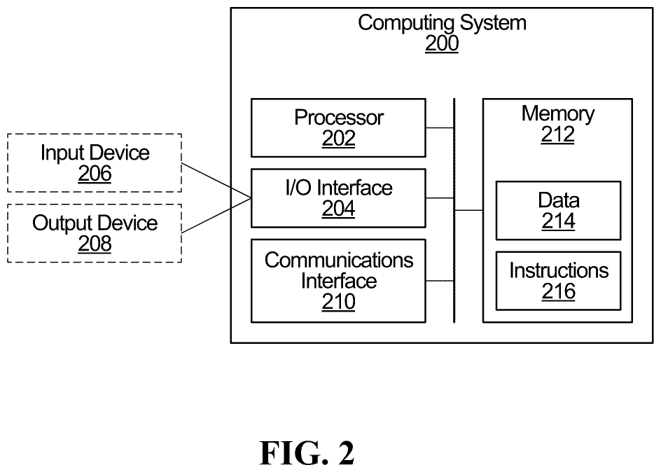

FIG. 2 is a block diagram illustrating an example hardware structure of a computing system 200 that is suitable for implementing example embodiments. Examples may be implemented in other computing systems, which may include components different from those described below. The computing system 200 may be used to execute instructions for automatically preparing or analyzing a spatial omics sample, in example embodiments. In examples, the computing system 200 (or plurality thereof) may be an example of, or be used to execute examples of, the strip dispenser assembly 110, the sample preparation assembly 120, the sample analysis assembly 130, the data processing module 140 or the strip update assembly 150.

Although FIG. 2 shows a single instance of each component, there may be multiple instances of each component in the computing system 200. Further, although the computing system 200 is illustrated as a single block, the computing system 200 may be a single physical machine or device (e.g., implemented as a single computing device, such as a single workstation, single end user device, single server, etc.) or the computing system may include a server device, a distributed computing system, a virtual machine running on an infrastructure of a datacenter, or infrastructure (e.g., virtual machines) provided as a service by a cloud service provider, among other possibilities.

The computing system 200 includes at least one processor 202, such as a central processing unit, a microprocessor, a digital signal processor, an application-specific integrated circuit (A SIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof.

The computing system 200 may include an input/output (I/O) interface 204, which may enable interfacing with an optional input device 206 and/or an optional output device 208. In the example shown, the optional input device 206 (e.g., a keyboard, a mouse, a microphone, a camera, a scanner, a touchscreen, and/or a keypad) and the optional output device 208 (e.g., a display, a speaker and/or a printer) are shown external to the computing system 200. In other example embodiments, there may not be any input device 206 and output device 208, in which case the I/O interface 204 may not be needed.

The computing system 200 may include at least one communications interface 210 for wired or wireless communication with other computing systems (e.g., other computing systems in a network). The communications interface 210 may include wired links (e.g., Ethernet cable) and/or wireless links (e.g., one or more antennas) for intra-network and/or inter-network communications.

The computing system 200 may include one or more memories 212 (individually or collectively referred to as “memory 212”), which may include a volatile or non-volatile memory (e.g., a flash memory, a random access memory (RAM), and/or a read-only memory (ROM)). The non-transitory memory 212 may store instructions 216 for execution by the processor 202, such as to carry out example embodiments. For example, the memory 212 may store instructions for implementing any of the methods of the examples and example embodiments. The memory 212 may include other software instructions, such as for implementing an operating system (OS) and other applications/functions.

The memory 212 may also include other data 214, information, rules, policies, and machine-executable instructions described herein, including, for example, spatial and single-cell multi-omics data 132 obtained for a biological sample 115.

In some examples, the memory 212 of the computing system 200 may also include one or more electronic storage units (not shown), such as a solid state drive, a hard disk drive, a magnetic disk drive and/or an optical disk drive. In some examples, data and/or instructions may be provided by an external memory (e.g., an external drive in wired or wireless communication with the computing system 200) or may be provided by a transitory or non-transitory computer-readable medium, which performs the function of the memory 212. Examples of non-transitory computer readable media include a RAM, a ROM, an erasable programmable ROM (EPROM), an electrically erasable programmable ROM (EEPROM), a flash memory, a CD-ROM, or other portable memory storage. The storage units and/or external memory may be used in conjunction with memory 212 to implement data storage, retrieval, and caching functions of the computing system 200. The components of the computing system 200 may communicate with each other via a bus, for example.

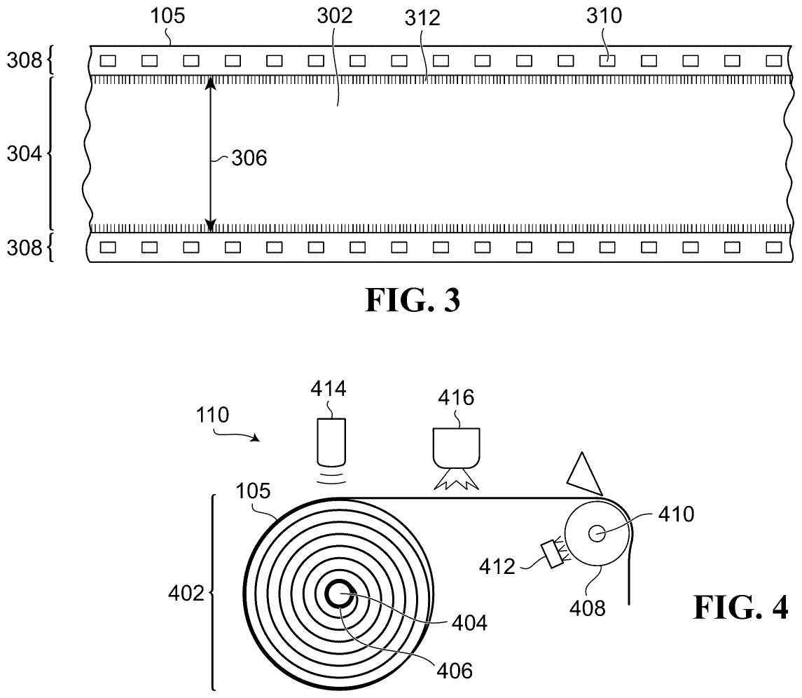

FIG. 3 is an example top view of a portion of the sample mounting strip 105, in accordance with example embodiments. In examples, the sample mounting strip 105 may be a thin, flexible strip, film or membrane of plastic or thermoplastic material, such as Polymethyl methacrylate (PMMA), polystyrene, polycarbonate, etc., or research grade filter paper, or a thin metal or foil (e.g., metal foil) or another suitable material may be used, where the sample mounting strip 105 has a top surface for receiving a biological sample 115 (e.g., sample receiving surface 302) and a bottom surface (not shown). In examples, the sample receiving surface 302 may receive the biological sample 115 as a thin section of a solid phase biological specimen (e.g., sectioned from a solid phase biological specimen using a microtome or cryotome and fixed to the sample receiving surface 302 of the sample mounting strip 105) or a liquid phase biological sample (e.g., which may be smeared along the sample receiving surface 302 of the sample mounting strip 105) or the biological sample may be received in another form. In some embodiments, for example, the sample mounting strip 105 may be transparent for improving the performance of diagnostic or analytical methods applied to the biological sample 115, or only a portion of the sample mounting strip 105 may be transparent. For example, a central region 304 of the sample mounting strip extending a predefined width 306 may be smooth or transparent for improving optical features, among others. In examples, the central region 304 may be bounded on either side by outer edge regions 308, where the outer edge regions 308 may exhibit a rough texture compared to the central region 304. In examples, the rough texture of the outer edge regions 308 may enable improved or strengthened attachment and/or adherence between the biological sample 115 and the sample receiving surface 302 of the sample mounting strip 105 (for example, during a freezing-attach process described below with respect to FIG. 8).

In examples, the sample mounting strip 105 may include a sequence of small holes or perforations 310 along each outer edge region 308 for facilitating the transport of the sample mounting strip 105 through the automatic spatial and single-cell multi-omics sample preparation and analysis system 100.

In some embodiments, for example, the sample mounting strip 105 may also include an encoding portion 312 positioned between the edge region 308 and the central region 304 of the sample mounting strip 105, for example, for being read by one or more slide position sensors as the sample mounting strip 105 is advanced through the spatial and single-cell multi-omics sample preparation and analysis system 100. In some embodiments, for example, the encoding region may be printed or fixed to a surface of the sample mounting strip 105 at manufacture, for example, on the bottom surface (not shown) of the sample mounting strip 105. In examples, when the sample mounting strip 105 is a transparent material, the encoding portion 312 may be visible to sensors configured to read the encoding portion 312 from a top surface of the sample mounting strip 105.

FIG. 4 is a schematic side view of an example strip dispenser assembly 110, in accordance with example embodiments. In examples, the strip dispenser assembly 110 dispenses a continuous length of the flexible sample mounting strip 105, which may be loaded on to a dispensing spool 402 or reel (e.g., wound on the dispensing spool), and which is dispensed by rotating the dispensing spool around an axis of rotation (e.g., an axle 404) to unwind the dispensing spool 402. In examples, the dispensing spool 402 may include flanges or rims (not shown) extending around the ends of the dispensing spool 402 to help retain the sample mounting strip 105 as it is wound on the dispensing spool 402. In examples, the dispensing spool 402 may also include a series of sprockets or projections (not shown) for receiving the perforations 310 of the sample mounting strip 105 to aid in advancing the sample mounting strip 105 through the spatial and single-cell multi-omics sample preparation and analysis system 100. In examples, a core of the dispensing spool 406 may be mounted on to a motor-controlled dispensing axle 404, enabling the dispensing spool 402 to be rotated in a first direction, where the speed and direction of rotation of the motor-controlled axle 404 for dispensing the sample mounting strip 105 may be controlled by the computing system 200.

In example embodiments, the sample mounting strip 105 may be fed from the dispensing assembly 110 through the sample preparation assembly 120 and the sample analysis assembly 130, where it is ultimately collected on an uptake spool of the strip uptake assembly 150. In examples, the sample mounting strip 105 may extend from the dispensing spool 402 and over a first roller 408 at a predefined distance from the dispensing spool 402, where it may then be received by the sample preparation assembly 120. In examples, the first roller 408 may be mounted on a first motor-controlled axle 410, enabling the first roller 408 to be rotated, where the speed and direction of rotation of the first motor-controlled axel 410 may be controlled by the computing system 200. In examples, the first roller 408 may also include a series of sprockets or projections (not shown) for receiving the perforations 310 of the sample mounting strip 105 to aid in transporting the sample mounting strip through the spatial and single-cell multi-omics sample preparation and analysis system 100. In some embodiments, for example, the first roller 408 may be equipped with an optional cleaning brush 412, for example, for mechanically removing dust or debris from the surface of the first roller 408 prior to contacting the sample mounting strip 105.

In example embodiments, a first slide position sensor 414 may be mounted proximal to the sample mounting strip 105 as it is dispensed from the dispensing spool 402, for determining a position of the sample mounting strip 105. For example, the first slide position sensor 414 may read the encoding portion 312 of the sample mounting strip 105 as it passes by the first slide position sensor 414, for indicating a position on the sample mounting strip 105. In example embodiments, an optional slide coating spray or smear unit 416 may also be mounted proximal to the sample mounting strip 105 as it is dispensed from the dispensing spool 402, for dispensing a fluid via a spray nozzle or smear plate on to the top surface (e.g., sample receiving surface 302) of the sample mounting strip 105 prior to contacting the first roller 408. In examples, the fluid may be a coating for preparing the top surface of the sample mounting strip 105 to bond with a biological sample more effectively. In examples, the fluid may include Poly-L-lysine slide pretreatment solution (e.g., for improving cell culture and which contains a glue substance), poly-L-lysine and water; tissue glue solution, and/or other assay-specific coating solutions. In examples, a gelatin solution is a commonly used adhesive compound for slide coating, as properties of the gelatin solution may help to retain tissue sections on histological slides during staining and washing steps of an assaying process. In examples, applying the fluid to the sample receiving surface 302 may optionally be performed during the manufacture of the sample mounting strip 105.

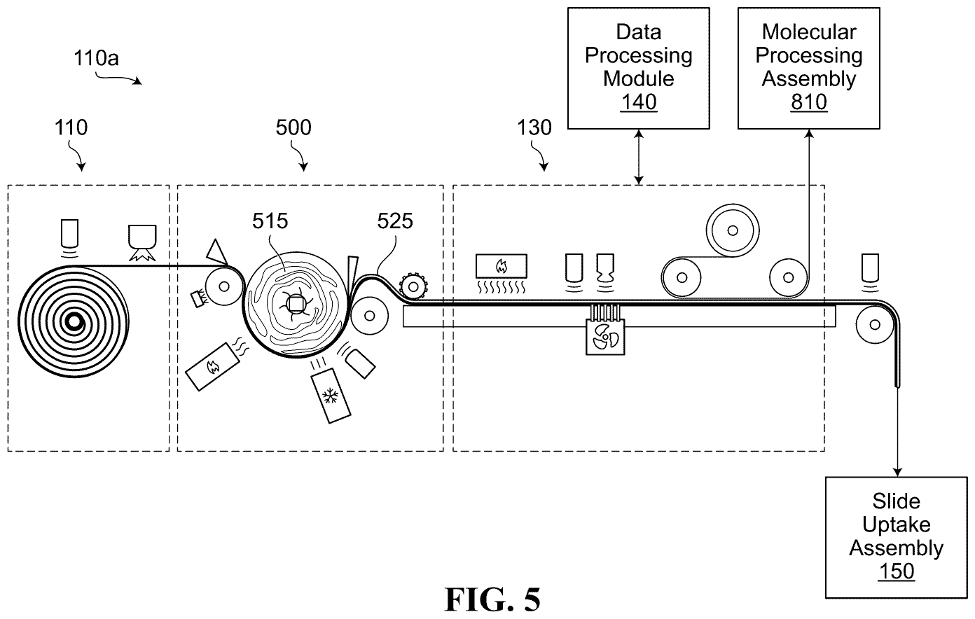

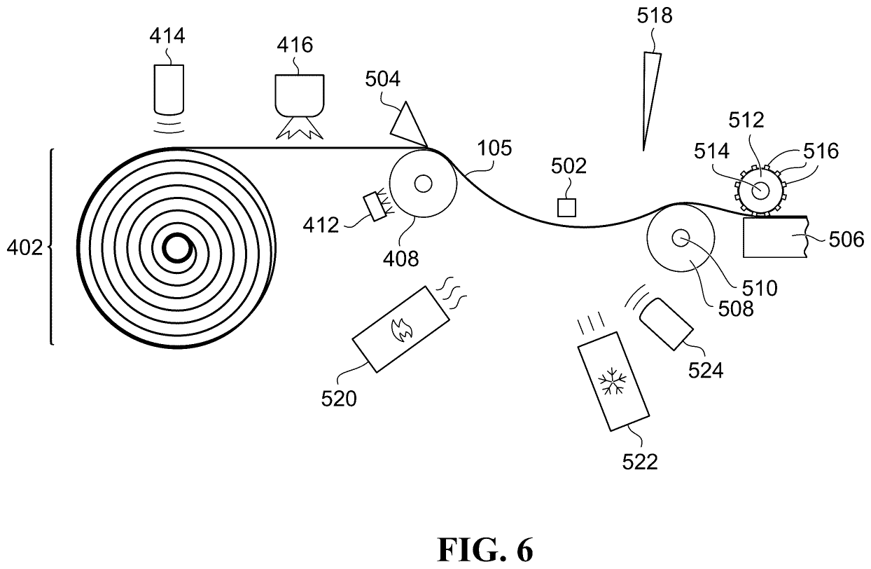

FIG. 5 is a schematic side view of an example embodiment of the automatic spatial and single-cell multi-omics sample preparation and analysis system 100a that is configured for preparing and analyzing a solid phase biological sample 515. In examples, the automatic spatial and single-cell multi-omics sample preparation and analysis system 100a includes the strip dispenser assembly 110 and a solid phase assembly 500, for preparing and mounting the solid phase biological sample 515 on to the sample mounting strip 105 to generate a prepared solid phase sample strip 525. In examples, the automatic spatial and single-cell multi-omics sample preparation and analysis system 100a also includes a sample analysis assembly 130 connected to a data processing module 140 and optionally, a molecular processing assembly 810, as well as a strip uptake assembly 150. Further details of the solid phase assembly 500 will now be described with respect to FIGS. 6-8 below and details of the sample analysis assembly 130 will be described with respect to FIG. 10 below.

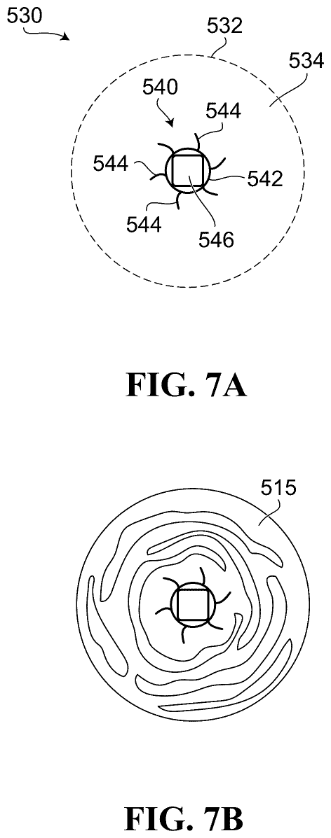

FIG. 6 is a schematic side view of an example embodiment of the solid phase assembly 500 in a pre-installed state, in cooperation with the strip dispenser assembly 110. In examples, the solid phase assembly 500 is depicted in a pre-installed state, for example, prior to installing the solid phase biological sample 515. In some embodiments, for example, the solid phase biological sample 515 may include a solid phase biological specimen embedded using optimal cutting temperature (OCT) compound prior to freezing, for example, in preparation for frozen sectioning (e.g., cryo-sectioning) using a microtome device such as a cryotome. In other embodiments, for example, a solid phase biological sample 515 may include a solid biological specimen embedded using a paraffin wax (e.g., using the formalin-fixed-paraffin-embedding (FFPE) approach) in preparation for tissue sectioning using a microtome device. In examples, the paraffin wax used for embedding the solid phase biological sample 515 may have melting points ranging from 56-62 degrees Celsius. In embodiments, the solid biological specimen may be arranged in a cylindrical specimen mold 530 (FIG. 7), for example, around a central axial assembly 540.

In example embodiments, the sample mounting strip 105 may be dispensed from the dispensing spool 402 and may extend over the first roller 408, where it is then positioned below a motor-controlled solid-phase sample axle 502 and extended over a second roller 508 at a predefined distance and vertically offset from the first roller 408. In examples, the second roller 508 may be situated in a vertical position that is lower than the first roller 408. In examples, the second roller 508 may be mounted on a second motor-controlled axle 510, enabling the second roller 508 to be rotated, where the speed and direction of rotation of the second motor-controlled axel 510 may be controlled by the computing system 200. In examples, the second roller 508 may also include a series of sprockets or projections (not shown) for receiving the perforations 310 of the sample mounting strip 105 to aid in transporting the sample mounting strip through the spatial and single-cell multi-omics sample preparation and analysis system 100a. The sample mounting strip 105 may then extend to a platform 506 which may function similarly to a conveyor belt, among other configurations. In examples the sample mounting strip 105 may be directed between the platform 506 and an optional rotating strip guide 512, for guiding the sample mounting strip 105 along the platform 506. In examples, the strip guide 512 may be mounted on a strip guide motor-controlled axle 514, enabling the strip guide 512 to be rotated, where the speed and direction of rotation of the strip guide 512 may be controlled by the computing system 200. In examples, the strip guide 512 may also include a series of sprockets or projections 516 for receiving the perforations 310 of the sample mounting strip 105 to aid in transporting the sample mounting strip through the spatial and single-cell multi-omics sample preparation and analysis system 100a.

In some embodiments, for example, the solid phase assembly 500 may also include an optional cold solution dispensing and smearing device 504, positioned proximal to the first roller 408, and a microtome blade-holder unit 518 (e.g., including a microtomy blade which can be installed on the blade holder), for example, positioned on a moveable arm (not shown), described in further detail with respect to FIG. 8 below. In some embodiments, for example, the solid phase assembly 500 may also include an optional heating unit 520, an optional cooling unit 522 and a second slide position sensor 524, positioned below the sample mounting strip 105, also described with respect to FIG. 8 below.

In some embodiments, for example, elements 504, 412, 410, 408, 520, 522, 515, 502 may be collectively positioned along a sample advancing track (not shown) such that during operation of the solid phase assembly 500, the elements may collectively advance toward the microtome blade-holder unit 518. For example, as a solid phase sample 515 is being sectioned, the diameter of the solid phase sample 515 will progressively decrease. Therefore, with every 360-degree rotation of the solid phase sample 515, the elements 504, 412, 410, 408, 520, 522, 515, 502 collectively, may advance a distance of between 5-30 micrometer (the thickness of the tissue section) as a whole toward the blade to compensate for the corresponding reduction in the diameter of the solid phase biological sample 515.

FIG. 7A is a schematic top view of an example cylindrical specimen mold 530, in accordance with example embodiments. In examples, the cylindrical specimen mold 530 may have a cylindrical outer wall 532 and a round base (not shown), where the cylindrical outer wall 532 and round base may be easily assembled and disassembled, for example, similar in form to a spring-form pan used for baking purposes. In examples, a central axial assembly 540 may be positioned at the center of the cylindrical specimen mold 530 for securing to one or more solid phase biological specimens (e.g., one or more solid phase biological tissues or a single solid phase biological tissue) in the cylindrical mold 530. In examples, the central axial assembly 540 may include a plurality of projections 544 extending outward from a circular frame 542 into a cavity 534 of the cylindrical mold 530. In examples, the plurality of projections 544 may be curved or angled for optimally securing the one or more solid phase biological specimens, or the projections 544 may be formed in other shapes. For example, the projections may aid in securing the one or more solid phase biological specimens such that when a sectioning process is performed, and a sectioning force is applied (e.g., in a downward direction) to a sectioning surface of the solid phase biological sample 515 by a microtomy blade while the solid phase biological specimens are rotating (e.g., counter-clockwise or in an opposite direction to the force applied by the microtomy blade edge) the projections 544 apply a holding force or friction force to the solid phase biological specimens that is equal to or greater than the sectioning force, thereby securing the solid phase biological specimens to the central axial assembly 540. In an example embodiment, the central axial assembly 540 is shown as having six projections 544 distributed equally around a circumference of the circular frame 542, however it should be understood that this is only exemplary and is not intended to be limiting, and other configurations may be used.

In examples, the cylindrical specimen mold 530 may be used to generate a solid phase biological sample 515 (as shown in FIG. 7B). For example, in response to placing one or more biological tissue specimens in the cavity 534 of the cylindrical specimen mold 530, the cylindrical specimen mold 530 may be filled with an embedding fluid (e.g., OCT compound or paraffin wax, among others) for embedding the specimens into a tissue block, for example, by freezing or by allowing the paraffin wax to harden. In examples, the tissue block (e.g., solid phase biological sample 515) may be removed from the cylindrical specimen mold 530, for example, the outer wall 532 and base of the cylindrical specimen mold 530 may be disassembled and separated from the embedded solid phase biological sample 515.

In examples, the central axial assembly 540 may include a cuboid shaped mounting hole 546 for mounting the solid phase biological sample 515 to a motor-controlled solid-phase sample axle 502, enabling the solid phase biological sample 515 to be rotated, where the speed and direction of rotation of the motor-controlled axel 502 may be controlled by the computing system 200.

FIG. 8 is a schematic side view of an example solid phase sample sectioning assembly 500, in accordance with example embodiments. In examples, the solid phase assembly 500 enables the sectioning of a solid phase biological sample 515 using a serial tissue block sectioning approach (e.g., continuous sectioning of the solid phase biological sample 515 using a rotating circular and/or spiral sectioning approach). M ore specifically, the solid phase assembly 500 receives the sample mounting strip 105 and enables an outer surface of the solid phase biological sample 515 (e.g., an attachment surface) to be fixed to the sample mounting strip 105 as the sample mounting strip 105 is advanced along the automatic spatial and single-cell multi-omics sample preparation and analysis system 100a. In examples, after the attachment surface of the solid phase biological sample 515 is fixed to the sample mounting strip 105, the solid phase biological sample 515 may be sectioned using a microtome blade-holder unit 518 to obtain a serial solid phase biological sample section. For example, a continuous section of the outer surface of the solid phase biological sample 515 may be obtained as the solid phase biological sample 515 rotates in a second direction (e.g., opposite to the first direction in which roller 408 rotates) about a motor-controlled solid-phase sample axle 502 with respect to a tip of a microtomy blade of the microtome blade-holder unit 518). In contrast to current solid phase sample sectioning approaches, in which discrete sections of a solid phase biological sample are obtained and mounted on to discrete glass slides, the proposed serial tissue block sectioning approach enables a serial solid phase biological sample section to span a continuous length congruent with the sample mounting strip 105. In this regard, the serial solid phase biological sample section remains fixed to the sample mounting strip 105 as it exits the solid phase assembly 500, where the combined sample mounting strip 105 and serial solid phase biological sample section represent the prepared solid phase sample strip 525. In some embodiments, for example, the solid phase assembly 500 may be installed within a cryostat device, for example, where the solid phase biological sample 515 is a frozen solid phase biological sample 515 and the temperature of the frozen solid phase biological sample 515 is maintained between −5 and −30 degrees Celsius.

In some embodiments, for example, the solid phase assembly 500 may include an optional cold solution dispensing and smearing device 504, positioned proximal to the first roller 408. In some embodiments, for example, where the solid phase biological sample 515 is a frozen state, for example, embedded using OCT compound prior to freezing, the optional solution dispensing and smearing device 504 may dispense a solution (e.g., a cold solution having a temperature between 0° to 4° C., or another solution) on to the sample receiving surface 302 of the sample mounting strip 105 for assisting in fixing a surface of the (frozen) solid phase biological sample 515 to the sample receiving surface 302 in response to the sample receiving surface 302 coming into contact with the surface of the (frozen) solid phase biological sample 515. For example, when a cold solution is applied onto the sample receiving surface 302 and the sample mounting strip 105 advances within the solid phase assembly 500 to contact the attachment surface of a frozen solid phase biological sample 515, an optional cooling unit 522 may cooperate with the sample mounting strip 105 and the solid phase biological sample 515 to freeze the cold solution and bond or fix the sample receiving surface 302 to the attachment surface of the solid phase biological sample 515. In examples, the frozen cold solution may remain frozen as the sample mounting strip progresses through the solid phase assembly 500, and the sample receiving surface 302 to the attachment surface of the solid phase biological sample 515 may remain fixed throughout a sectioning process where a thin tissue slice is sectioned from the solid phase biological sample 515 while remaining fixed to the sample receiving surface 302. In examples, the thin section of tissue that remains attached to the sample receiving surface 302 may be as thin as 5 micrometers and as thick as 30 to 50 micrometers. In examples, a cold solution may include molecular biology degree water or any coating solution or glue (e.g., tissue glue), for example, as described with respect to FIG. 4.

In other examples, when the solid phase biological sample 515 is not a frozen solid phase biological sample 515, such as when the solid phase biological sample 515 is a FFPE tissue block, another solution or no solution may be dispensed and smeared on to the sample receiving surface 302 for assisting in fixing a surface of the (FFPE) solid phase biological sample 515 to the sample receiving surface 302. For example, the solution may be a glue such as a tissue glue, or another glue may be used. In examples, the optional cooling unit 522 may not be used as the glue will act to attach the attachment surface of the solid phase biological sample 515 onto the sample receiving surface 302.

In examples, the sample mounting strip 105 may be advanced over the first roller 408 as the first roller 408 rotates in a first direction (e.g., clockwise), and the central axial assembly 540 may rotate in a second direction (e.g., anti-clockwise) with respect to the first roller 408 causing the solid phase biological sample 515 to also rotate in the second direction. In examples, the rotating may cause the attachment surface of the solid phase biological sample 515 to be brought into compressive contact with the sample receiving surface 302 of the flexible sample strip 105, the compressive contact causing the flexible sample strip and the solid phase biological sample to be fixedly attached. For example, a surface of the first roller 408 may be positioned with respect to the attachment surface of the solid phase biological sample 515 such that a compressive force is applied to the sample receiving surface 302 of the sample mounting strip 105 and the attachment surface of the solid phase biological sample 515 as it advances over the first roller 408. In some embodiments, for example, the attached solid phase biological sample 515 and sample receiving strip 105 may traverse an optional heating unit 520. For example, if the solid phase biological sample 515 is a FFPE solid phase biological sample 515, the heating unit 520 may apply heat to the FFPE solid phase biological sample 515 to substantially melt a portion of the wax embedding the biological tissue at the contact surface with the sample receiving strip 105 for ensuring the sample receiving surface 302 remains securely fixed to the surface of the FFPE solid phase biological sample 515. In some embodiments, for example, the attached solid phase biological sample 515 and sample receiving strip 105 may traverse an optional cooling unit 522. For example, if the solid phase biological sample 515 is a frozen solid phase biological sample 515, the cooling unit 522 may assist in maintaining a desired temperature of the frozen solid phase biological sample 515. In other embodiments, for example, if the solid phase biological sample 515 is a FFPE solid phase biological sample 515, the cooling unit 522 may enable the re-hardening of the wax embedding the biological tissue, for example, at the attachment surface with the sample receiving strip 105 for ensuring the sample receiving surface 302 remains securely fixed to the attachment surface of the FFPE solid phase biological sample 515.

In examples, the attached solid phase biological sample 515 and sample receiving strip 105 may traverse a second slide position sensor 524 for determining a position of the sample mounting strip 105. For example, the second slide position sensor 524 may read the encoding portion 312 of the sample mounting strip 105 as it rotates past the second slide position sensor 524, for indicating a position on the sample mounting strip 105.

In examples, the microtome blade-holder unit 518 (e.g., including a microtomy blade and a blade holder) may be positioned in proximity to the second roller 508 in preparation for sectioning the solid phase biological sample 515. In examples, the microtomy blade may be installed into the blade holder and the blade holder may be coupled to a moveable arm of the microtome blade-holder unit 518, such that the arm (and the microtomy blade) can be automatically moved up and down. In examples, the microtomy blade may be moved down from a holding position to a sectioning position, where the blade may be in contact with the solid phase biological sample 515. In examples, a serial solid phase biological sample section may be obtained as the surface of the solid phase biological sample 515 rotates past a tip of the microtomy blade while the microtomy blade is in contact with the solid phase biological sample 515. In examples, the second roller 508 may be a precision section guide wheel, for example, for guiding the microtome blade-holder unit 518 for precisely sectioning the solid phase biological sample 515. In examples, the serial solid phase biological sample section may remain fixed to the sample receiving surface 302 of the sample mounting strip 105 as the serial solid phase biological sample is sectioned from the solid phase biological sample 515, forming the prepared solid phase sample strip 525. In examples, the prepared solid phase sample strip 525 may be transported along a path through the solid phase assembly 500 and may contact the strip guide 512 at platform 506 where it may be received by the sample analysis assembly 130. In examples, the path followed by the prepared solid phase sample strip 525 may be such that a gap 526 may be formed in a region between the second roller 508 and the strip guide 512, for example, for reducing a tangential compressive stress and/or a tension applied to the prepared solid phase sample strip 525 for ensuring that the serial solid phase biological sample section remains fixed to the sample receiving surface 302 of the sample mounting strip 105 as the prepared solid phase sample strip 525 is transported through the solid phase assembly 500. In some embodiments, for example, the prepared solid phase sample strip 525 may be oriented in a substantially vertical position proximal to the microtome blade-holder unit 518 however the prepared solid phase sample strip 525 may need to transition to a substantially horizontal position proximal to the platform 506, therefore the gap 526 may enable a gentler transition.

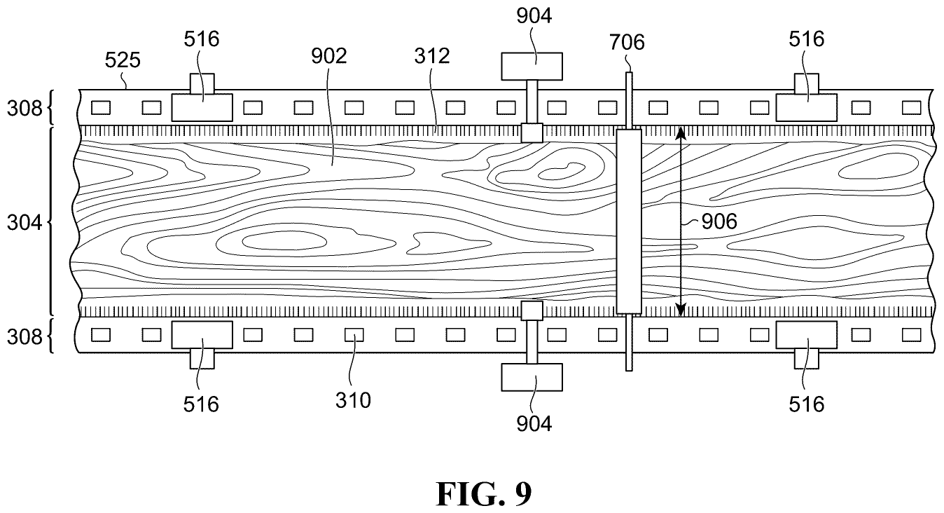

FIG. 9 is an example top view of a portion of the prepared solid phase sample strip 525, in accordance with example embodiments. In examples, the prepared solid phase sample strip 525 may include a serial solid phase biological sample section 902 secured to the sample receiving surface 302 and extending a predefined width 906. In examples, the serial solid phase biological sample section 902 may be positioned within the central region 304, enabling the encoding portion 312 (e.g., positioned between the edge region 308 and the central region 304) to be read by one or more strip position sensors 904. In some embodiments, for example, other sensors or scanners (e.g., imaging device scanner 706) may be positioned to scan or analyze the serial solid phase biological sample 902, as described with respect to FIG. 10 below.

In examples, perforations 310 along each outer edge region 308 may be received by one or more sprockets or projections 516 of one or more strip guides 512 to aid in transporting the sample mounting strip through the spatial and single-cell multi-omics sample preparation and analysis system 100a.

FIG. 10 is a schematic side view of an example embodiment of the sample analysis assembly 130, in cooperation with the strip uptake assembly 150. In examples, the sample analysis assembly 130 may include an assaying assembly 700, a multi-omics profiling assembly 800 and an imaging assembly 900. In some embodiments, for example, the prepared solid phase sample strip 525 may be advanced through the sample analysis assembly 130 for analyzing the serial solid phase biological sample section 902 to obtain spatial and single-cell multi-omics data 132, for example, using various sensors and/or technologies as it is conveyed along the platform 506 (e.g., conveyed with assistance from one or more strip guides 512 positioned along the platform 506). In other embodiments, for example, a prepared liquid phase sample strip 625 (e.g., described with respect to FIG. 12 below) may be advanced through the sample analysis assembly 130 for analyzing a liquid phase biological sample 615 to obtain spatial and single-cell multi-omics data 132, for example, using various sensors and/or technologies as it is conveyed along the platform 506 (e.g., conveyed with assistance from one or more strip guides 512 positioned along the platform 506). In this regard, although the assemblies 700, 800 and 900 are described in a certain order, it is understood that the assemblies 700, 800 and 900 may be arranged in other orders, or that more than one of each of the assemblies 700, 800 and 900 may be used and/or omitted.

In examples, the imaging assembly 700 may include a heating blow dry unit 702, for example, for preparing the serial solid phase biological sample section 902 for analysis. In examples, the heating blow dry unit 702 may apply a stream of warm air to the serial solid phase biological sample section 902, among other preparations. In examples, the imaging assembly 700 may also include one or more slide position sensors 904 for reading one or more positions of the prepared solid phase sample strip 525. In examples, the imaging assembly 700 may also include one or more imaging device scanners 706. In examples, vacuum device 708 may be positioned on an underside of the platform 506 in proximity to the one or more imaging devices scanners 706, for example, for drawing air through one or more openings 710 (e.g., rows of small holes or a grid of small holes, or rows of slits, among other openings) in the platform 506 for creating a suction. In examples, the suction caused by the vacuum device 708 may be beneficial for ensuring that the prepared solid phase sample strip 525 is sufficiently flat to the platform 506 during scanning by the one or more imaging device scanners 706. In examples, imaging data (e.g., spatial and single-cell multi-omics data 132) obtained from the one or more imaging device scanners 706 may be provided to the data processing module 140 for analysis.

In examples, the multi-omics profiling assembly 800 may include a molecular extraction assembly, for example, for extracting DNA, RNA, proteins etc. from the serial solid phase biological sample section 902. In examples, the multi-omics profiling assembly 800 may include a molecular strip dispenser assembly for dispensing a continuous length of a flexible molecular sample mounting strip 805 from a dispensing spool 802 or reel (e.g., wound on the dispensing spool 802), and which is dispensed by rotating the dispensing spool 802 in a first direction around an axis of rotation (e.g., an axle) to unwind the dispensing spool 802, where the speed and direction of rotation of the dispensing spool 802 may be controlled by the computing system 200. In examples, the molecular sample mounting strip 805 may be pre-coated with barcoded capture molecules such as Oligo nucleotides and antibody or other chemical substances on the molecular sample mounting surface of the molecular sample mounting strip 805. In examples, the dispensing spool 802 may include flanges or rims (not shown) extending around the ends of the dispensing spool 802 to help retain the molecular sample mounting strip 805 as it is wound on the dispensing spool 802. In examples, the dispensing spool 802 may also include a series of sprockets or projections (not shown) for receiving perforations of the molecular sample mounting strip 805 to aid in advancing the molecular sample mounting strip 805 through the multi-omics profiling assembly 800.

In example embodiments, the molecular sample mounting strip 805 may extend from the dispensing spool 802 and over and/or around a roller 806 at a predefined distance from the dispensing spool 802 and a roller 808 at a predefined distance from roller 806. In examples, the rollers 806 and 808 may be mounted on respective motor-controlled axles, enabling the rollers 806 and 808 to be rotated, where the speed and direction of rotation of the motor-controlled axels may be controlled by the computing system 200. In examples, the rotating may cause the molecular sample mounting surface of the molecular sample mounting strip 805 to be brought into compressive contact with the prepared solid phase sample strip 525, for example, for extracting or transferring a biological content from the biological sample on the prepared solid phase sample strip 525 to the molecular sample mounting strip 805. In examples, the rollers 806 and/or 808 may include a series of sprockets or projections (not shown) for receiving the perforations of the sample mounting strip 105 or the molecular sample mounting strip 805 to aid in transporting both the sample mounting strip 105 and the molecular sample mounting strip 805 through the multi-omics profiling assembly 800.

In example embodiments, a slide coating spray or smear unit 804 may be mounted proximal to the molecular sample mounting strip 805 as it is dispensed from the dispensing spool 802, for dispensing a fluid via a spray nozzle or smear plate on to the molecular sample mounting strip 805 prior to contacting the roller 806. In examples, the fluid may be a reagent or a biochemical substance or solution for use in assaying analysis.

Additional rollers (not shown) may further direct the molecular sample mounting strip 805 through the multi-omics profiling assembly 800 and corresponding extracted molecular samples may be provided to the molecular processing assembly 810 for further analysis (e.g., DNA/RNA sequencing or other molecular imaging procedures). In examples, molecular data (e.g., spatial and single-cell multi-omics data 132) obtained from the molecular processing assembly 810 may further be provided to the data processing module 140 for analysis.

In examples, the data processing module 140 may perform data integration and reconstruction of solid phase biological samples 515, for example, for integrating data obtained by one or more slide position sensors with and multi-omics imaging and sequencing data, etc., and for reconstructing the data (e.g., the cell and molecular composition of the biological tissue or organ) in 3-dimensions. For example, a typical pancreas may measure about 15 cm by 7 cm by 4 cm (thus having a corresponding volume of approximately 420 cm³), and can be arranged in various shapes in the cylindrical mold 530 prior to sectioning. However, after the pancreas tissue has been sectioned and during assaying, the tissue sample is arranged in a flat 2D plane. The corresponding data therefore can be processed to arrange the tissue sections in a curved shape and reconstruct a corresponding 3D digital pancreas. This reconstruction can be performed by CT or MRI instruments (e.g., within a hospital setting) but at very low resolution. In examples, for a liquid phase sample, the data processing module 140 may simply collect and analyze the cellular and molecular information of the liquid phase sample.

In examples, although the sample analysis assembly 130 is described within the context of the automatic spatial and single-cell multi-omics sample preparation and analysis system 100a that is configured for preparing and analyzing a solid phase biological sample 515, it is understood that this example is not meant to be limiting. In examples, that the sample analysis assembly 130 may be applicable as described within other embodiments of the automatic spatial omics sample preparation and analysis system 100, such as a system configured for preparing and analyzing a liquid phase biological sample, among others forms of biological samples.

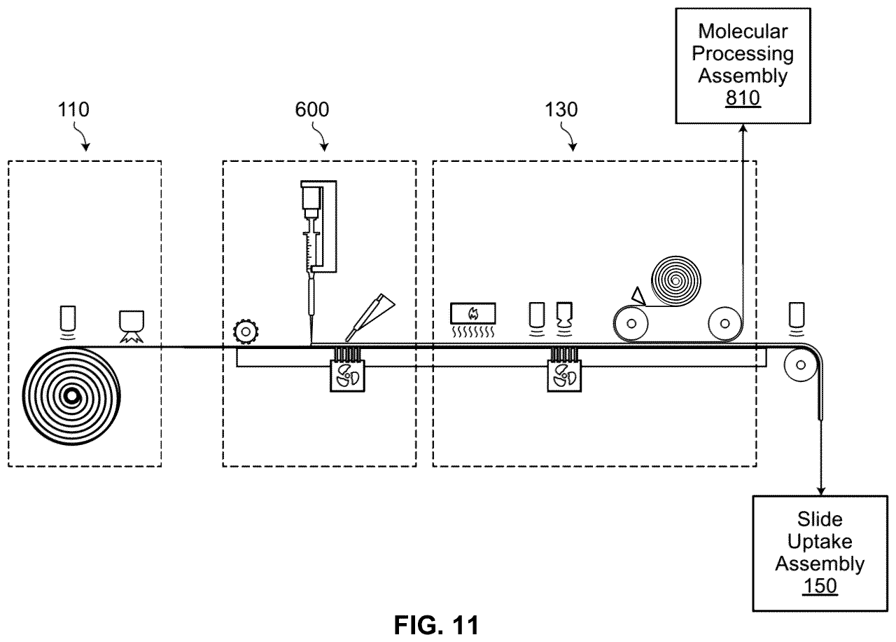

FIG. 11 is a schematic side view of an example embodiment of the automatic spatial and single-cell multi-omics sample preparation and analysis system 100b that is configured for preparing and analyzing a liquid phase biological sample 615. In examples, the automatic spatial and single-cell multi-omics sample preparation and analysis system 100b includes the strip dispenser assembly 110 and a liquid phase assembly 600, for preparing and mounting the liquid phase biological sample 615 on to the sample mounting strip 105 to generate a prepared liquid phase sample strip 625. In examples, the automatic spatial omics sample preparation and analysis system 100b also includes a sample analysis assembly 130 connected to a data processing module 140 and optionally, a molecular processing assembly 810, as well as a strip uptake assembly 150. Further details of the liquid phase assembly 600 will now be described with respect to FIG. 12 below.

FIG. 12 is a schematic side view of an example embodiment of the liquid phase sample smearing assembly 600. In examples, the liquid phase biological sample 615 may include a suspension of biological tissue cells, for example, at a predetermined concentration. In some examples, the concentration may be determined for enabling an even distribution of a single layer of biological tissue cells or a partial layer of biological tissue cells, among other possibilities. In examples, the liquid phase biological sample 615 may be loaded into a disposable syringe 602 for dispensing on to the sample mounting strip 105 for performing single cell smear cytometry, for example, for the combined analysis of single cells surface marker and multi-omics, among other possibilities.

In example embodiments, the sample mounting strip 105 may be dispensed from the dispensing spool 402 as described with respect to FIG. 4. In examples, the sample mounting strip 105 may be received by the liquid phase assembly 600, for example, the sample mounting strip may extend to the platform 506 and may be received by an optional strip guide 612, for guiding the sample mounting strip 105 along the platform 506. In examples, the strip guide 612 may be mounted on a strip guide motor-controlled axle 614, enabling the strip guide 612 to be rotated, where the speed and direction of rotation of the strip guide 612 may be controlled by the computing system 200. In examples, the strip guide 612 may also include a series of sprockets or projections 516 for receiving the perforations 310 of the sample mounting strip 105 to aid in advancing the sample mounting strip through the spatial and single-cell multi-omics sample preparation and analysis system 100b.

In examples, the liquid phase biological sample 615 may be dispensed on to the sample mounting strip 105 at a pre-determined rate using a syringe controller 604. For example, the syringe controller 604 may interact with the syringe 602 for automatically and continuously dispensing a pre-determined volume of the liquid phase biological sample 615 out of a nozzle 606 and on to the sample mounting strip 105 at a pre-determined speed, for example, based on the speed at which the sample mounting strip 105 is being conveyed along the platform 506, or based on the diameter of the nozzle 606, among other possibilities. In examples, the speed at which the syringe controller 604 dispenses the liquid phase biological sample 615 out of the syringe may be controlled by the computing system 200. In some embodiments, for example, the nozzle 606 may be connected to the syringe 602 by a connection tube 608.

In examples, once the liquid phase biological sample 615 has been dispensed on to the sample mounting strip 105, the liquid phase biological sample 615 may be smeared on to the sample mounting strip 105, for example, using a smearing plate 610. In examples, the smearing plate 610 may be a glass plate or a stainless steel plate, or another material may be used. In examples, the smearing plate 610 may be configured such that the width of the smearing plate 610 is equal to or smaller than the predefined width 306 of the central region 304 of the sample mounting strip 105. In examples, the smearing plate 610 may be fixed within a plate holder 616 in a smearing position, for example, at a pre-determined distance from the sample mounting strip 105 and at a pre-determined angle with respect to the platform 506, for contacting the dispensed liquid phase biological sample 615 on the sample mounting strip 105 and spreading the liquid phase biological sample 615 over the sample receiving surface 302 of the sample mounting strip 105 with a pre-determined thickness, for example, to generate the prepared liquid phase sample strip 625.

In examples, vacuum device 620 may be positioned on an underside of the platform 506 in proximity to the smearing plate 610, for example, for drawing air through one or more openings 622 (e.g., rows of small holes or a grid of small holes, or rows of slits, among other openings) in the platform 506 for creating a suction. In examples, the suction caused by the vacuum device 620 may be beneficial for ensuring that the prepared liquid phase sample strip 625 is sufficiently flat to the platform 506 during the smearing procedure. The prepared liquid phase sample strip 625 may then be received by the sample analysis assembly 130 as previously described with respect to FIG. 10.

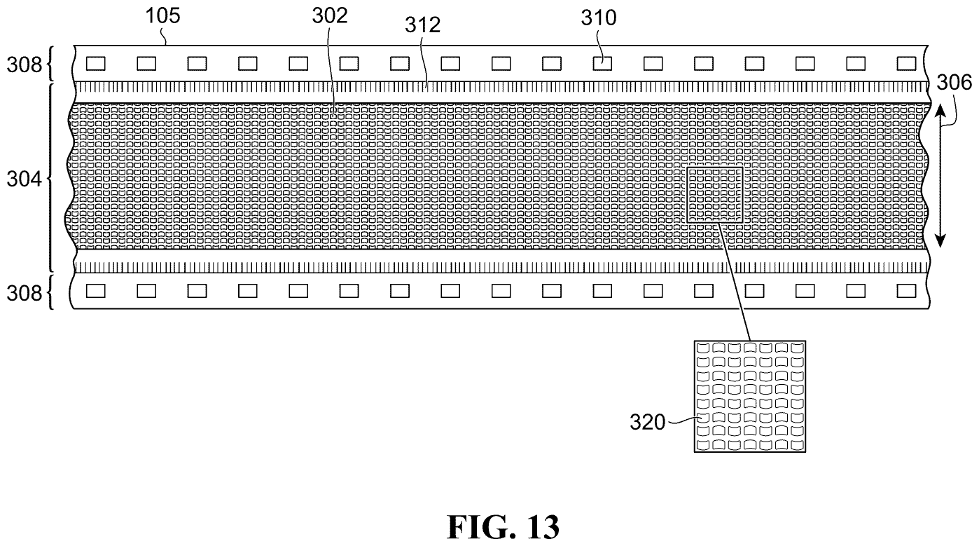

FIG. 13 is an example top view of an example embodiment of the sample mounting strip 105, for example, for use in a live cell suspension smear and live culture assaying and profiling. In examples, the sample mounting strip 105 may be a thin, flexible strip of plastic or another suitable material having a top surface (e.g., sample receiving surface 302), a bottom surface (not shown) and a plurality of micro-wells 320 formed in the sample receiving surface 302, for receiving a liquid phase biological sample 615. In examples, the liquid phase biological sample 615 may include a suspension of biological tissue cells, for example, at a predetermined concentration. In some examples, the concentration may be determined for enabling an even distribution of biological tissue cells in each of the micro-wells 320. In examples, the liquid phase biological sample 615 may be loaded into each of the micro-wells 320 to generate a prepared liquid phase sample strip 625 by dispensing a pre-determined volume of the liquid phase biological sample 615 on to the sample receiving surface 302 using a syringe 602 and smearing the liquid phase biological sample 615 using a smearing plate 610, as previously described with respect to FIG. 12.

In some embodiments, for example, the sample mounting strip 105 may be transparent for improving the performance of diagnostic methods applied to the liquid phase biological sample 615, or only a portion of the sample mounting strip 105 may be transparent. For example, a central region 304 of the sample mounting strip extending a predefined width 306 may be smooth or transparent for improving optical features, among others. In examples, the central region 304 may be bounded on either side by an outer edge region 308, where the outer edge region may exhibit a rough texture compared to the central region 304.

In examples, the sample mounting strip 105 may include a sequence of small holes or perforations 310 along each outer edge region 308 for facilitating the transport of the sample mounting strip 105 through the automatic spatial and single-cell multi-omics sample preparation and analysis system 100. In some embodiments, for example, the edge region of the sample mounting strip 105 may exhibit a rough texture, for example, for promoting friction with various sprocket-containing components of the strip dispenser assembly 110 and the strip uptake assembly 150, among others, for assisting in the transport or advancing of the sample mounting strip 105 through the spatial omics sample preparation and analysis system 100.

In some embodiments, for example, the sample mounting strip 105 may also include an encoding portion 312 positioned between the edge region 308 and the central region 304 of the sample mounting strip 105, for example, for being read by one or more slide position sensors as the sample mounting strip 105 is transported through the spatial and single-cell multi-omics sample preparation and analysis system 100. In some embodiments, for example, the encoding region may be printed or fixed to a surface of the sample mounting strip 105 at manufacture, for example, on the bottom surface (not shown) of the sample mounting strip 105. In examples, when the sample mounting strip 105 is a transparent material, the encoding portion 312 may be visible to sensors configured to read the encoding portion 312 from a top surface of the sample mounting strip 105.

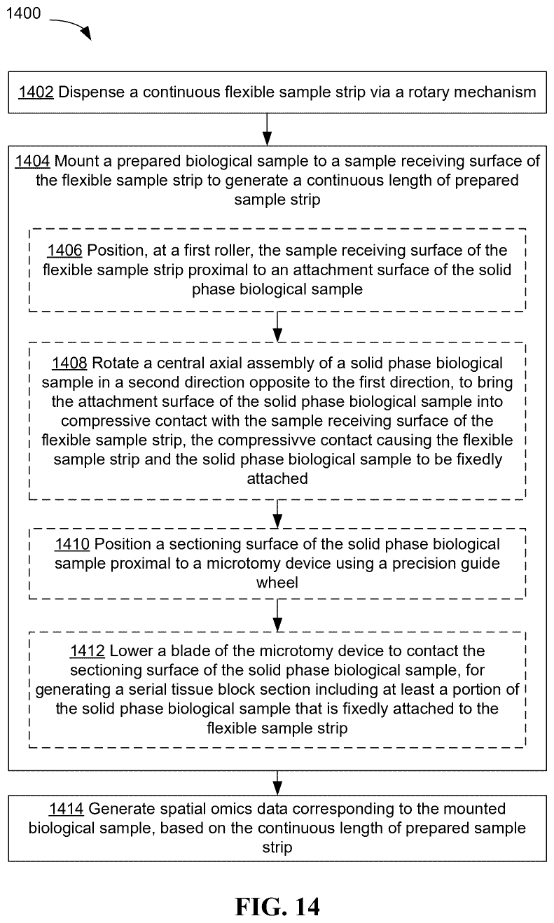

FIG. 14 is a flowchart illustrating an example method 1400 for automatic spatial and single-cell multi-omics sample preparation and analysis. In some embodiments, for example, the method may be directed to preparing and analyzing a solid phase biological sample, such as an OCT embedded frozen tissue block or a FFPE tissue block.

Method 1400 begins with step 1402, in which a continuous flexible sample strip 105 is dispensed from a strip dispenser assembly 110, via a rotary mechanism. In examples, the continuous flexible sample strip 105, may be pre-loaded on to a dispensing spool 402 or reel (e.g., wound on the dispensing spool), and may be dispensed by rotating the dispensing spool around an axis of rotation (e.g., an axle 404) to unwind the dispensing spool 402. In examples, in response to being dispensed from the strip dispenser assembly 110, a fluid spray coating may be dispensed on to a sample receiving surface 302 of the continuous flexible sample strip 105 via a spray nozzle of a slide coating spray unit 416. In examples, the fluid may be a coating for enabling the sample receiving surface 302 to bond with or attach to an attachment surface of a solid phase biological sample more effectively.

At step 1404, a prepared biological sample 115 may be mounted to the sample receiving surface 302 of the flexible sample strip 105 to generate a continuous length of prepared sample strip 125. In some embodiments, for example, the prepared biological sample 115 may be a solid phase biological sample 515 that has been prepared in a cylindrical specimen mold 530 (for example, by placing one or more biological specimens that have been secured to a central axial assembly 540 along with cold OCT or hot melted paraffin wax into the cylindrical specimen mold 530 and allowing the contents of the mold to harden, such as by cooling the filled mold to room temperature for paraffin wax embedded tissue, or to lower than −20 degrees Celsius to freeze), and mounted on the solid-phase sample axle 502 of the solid phase assembly 500. In examples, mounting the prepared biological sample 515 to the sample receiving surface 302 of the flexible sample strip 105 may include the following steps.

At step 1406, the sample receiving surface 302 of the flexible sample strip 105 may be positioned, at a first roller 408, proximal to the attachment surface of the solid phase biological sample 515, wherein rotating the first roller 408 in a first direction advances the flexible sample strip 105 toward the solid phase biological sample 515.

At step 1408, rotating a central axial assembly 540 of the solid phase biological sample 515 in a second direction opposite to the first direction, may bring the attachment surface of the solid phase biological sample 515 into compressive contact with the sample receiving surface 302 of the flexible sample strip 105, such that the compressive contact causes the flexible sample strip 105 and the solid phase biological sample 515 to be fixedly attached.

At step 1410, a sectioning surface of the solid phase biological sample 515 may be positioned proximal to a microtomy device (e.g., microtome blade-holder unit 518) using a second roller 508, such as a precision guide wheel.

At step 1412, while the first roller 408 rotates in the first direction and the central axial assembly 540 of the solid phase biological sample 515 rotates in the second direction, a blade of the microtomy device may be lowered to contact the sectioning surface of the solid phase biological sample 515, for generating a serial tissue block section including at least a portion of the solid phase biological sample that is fixedly attached to the flexible sample strip, for example, representative of as the continuous length of prepared sample strip 125.

At step 1414, spatial and single-cell multi-omics data 132 corresponding to the mounted biological sample, may be generated based on the continuous length of prepared sample strip 125. In examples, the prepared sample strip 125 may be conveyed past one or more assaying assemblies 700, for example, for tissue pre-treatment (e.g., for preserving the state of tissue before analysis, such as via heat, freezing, chemical fixation, enzymes etc., among other procedures), and then advanced to one or more imaging device scanners 706, where the one or more imaging device scanners 706 may scan the biological sample 115 mounted on the prepared sample strip 125 to generate imaging data. In examples, the prepared sample strip 125 may be conveyed through a molecule extraction assembly, for example, for extracting DNA, RNA, proteins etc. from the prepared sample strip 125. In examples, extracted molecular samples may be provided to the molecular processing assembly 810 for further analysis. In examples, spatial and single-cell multi-omics data 132 obtained from the one or more imaging device scanners 706 and/or obtained from the molecular processing assembly 810 may be analyzed.

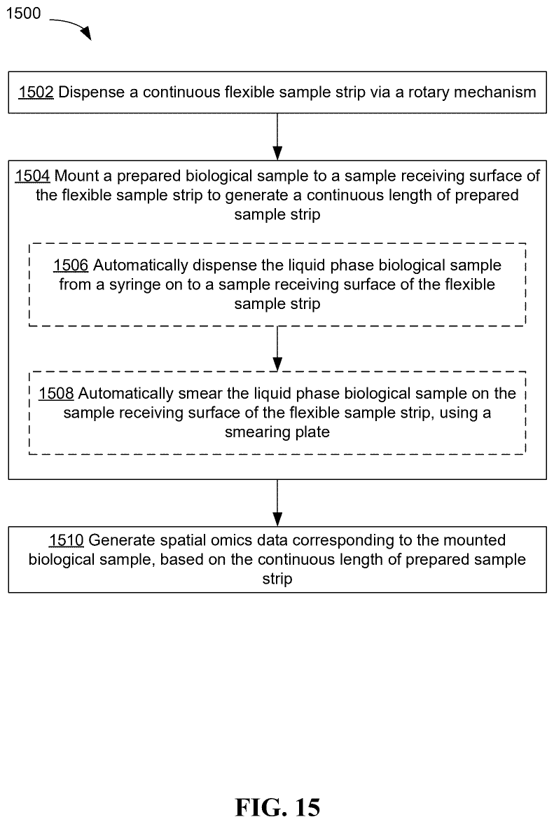

FIG. 15 is a flowchart illustrating an example method 1500 for automatic spatial and single-cell multi-omics sample preparation and analysis. In some embodiments, for example, the method may be directed to preparing and analyzing a liquid phase biological sample.

Method 1500 begins with step 1502, in which a continuous flexible sample strip 105 is dispensed from a strip dispenser assembly 110, via a rotary mechanism. In examples, the continuous flexible sample strip 105, may be pre-loaded on to a dispensing spool 402 or reel (e.g., wound on the dispensing spool), and may be dispensed by rotating the dispensing spool around an axis of rotation (e.g., an axle 404) to unwind the dispensing spool 402.

At step 1504, a prepared biological sample 115 may be mounted to a sample receiving surface 302 of the flexible sample strip 105 to generate a continuous length of prepared sample strip 125. In some embodiments, for example, the prepared biological sample 115 may be a liquid phase biological sample 615, and mounting the prepared biological sample 615 to the sample receiving surface 302 of the flexible sample strip 105 may include the following steps.

At step 1506, automatically dispense the liquid phase biological sample 615 from a syringe 602, on to a sample receiving surface 302 of the of the flexible sample strip 105.

At step 1508, automatically smear the liquid phase biological sample 615 on the sample receiving surface 302 of the flexible sample strip 105, using a smearing plate 610.

At step 1510, spatial and single-cell multi-omics data 132 corresponding to the mounted biological sample, may be generated based on the continuous length of prepared sample strip 125. In examples, the prepared sample strip 125 may be conveyed past one or more assaying assemblies 700, for example, for tissue pre-treatment (e.g., for preserving the state of tissue before analysis, such as via heat, freezing, chemical fixation, enzymes etc., among other procedures), and then advanced to imaging device scanners 706, where the one or more imaging device scanners 706 may scan the biological sample 115 mounted on the prepared sample strip 125 to generate imaging data. In examples, the prepared sample strip 125 may be conveyed through a molecule extraction assembly, for example, for extracting DNA, RNA, proteins etc. from the prepared sample strip 125. In examples, extracted molecular samples may be provided to the molecular processing assembly 810 for further analysis. In examples, spatial and single-cell multi-omics data 132 obtained from the one or more imaging device scanners 706 and/or obtained from the molecular processing assembly 810 may be analyzed.

Although the example embodiments relate to methods and processes with steps in a certain order, one or more steps of the methods and processes may be omitted or altered as appropriate. One or more steps may take place in an order other than that in which they are described, as appropriate.

Although example embodiments are described, at least in part, in terms of methods, a person of ordinary skill in the art will understand that the example embodiments are also directed to the various components for performing at least some of the aspects and features of the described methods, be it by way of hardware components, software or any combination of the two. Accordingly, the technical solution of the example embodiments may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable an electronic device (e.g., a personal computer, a server, or a network device) to execute examples and example embodiments of the methods.

In the described methods, systems, devices, or block diagrams, the boxes may represent events, steps, functions, processes, modules, messages, and/or state-based operations, etc. While some of the example embodiments have been described as occurring in a particular order, some of the steps or processes may be performed in a different order provided that the result of the changed order of any given step will not prevent or impair the occurrence of subsequent steps. Furthermore, some of the messages or steps described may be removed or combined in other embodiments, and some of the messages or steps described herein may be separated into a number of sub-messages or sub-steps in other embodiments. Even further, some or all of the steps may be repeated, as necessary. Elements described as methods or steps similarly apply to systems or subcomponents, and vice-versa. Reference to such words as “sending” or “receiving” could be interchanged depending on the perspective of the particular device.

The example embodiments may be embodied in other specific forms without departing from the subject matter of the example embodiments. The described example embodiments are to be considered in all respects as being only illustrative and not restrictive. Selected features from one or more of the above-described embodiments may be combined to create alternative embodiments not explicitly described, features suitable for such combinations being understood within the scope of the example embodiments.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover all suitable changes in technology.

1. A system for automatic spatial and single-cell multi-omics sample preparation and analysis, comprising:
a dispensing assembly for dispensing a continuous flexible sample strip via a rotary mechanism;
a sample preparation assembly for mounting a prepared biological sample to a sample receiving surface of the flexible sample strip to generate a continuous length of prepared sample strip; and
a sample analysis assembly for generating spatial and single-cell multi-omics data corresponding to the mounted biological sample, based on the continuous length of prepared sample strip.

2. The system of claim 1, wherein the prepared biological sample is a solid phase biological sample.

3. The system of claim 2, wherein the sample preparation assembly comprises:
a first roller that rotates in a first direction, the first roller for receiving the flexible sample strip from the dispensing assembly, advancing the flexible sample strip toward the solid phase biological sample and positioning the sample receiving surface of the flexible sample strip proximal to an attachment surface of the solid phase biological sample;
a central axial assembly for coupling the solid phase biological sample to a motor-controlled axle that rotates in a second direction opposite to first direction, wherein rotating the central axial assembly in the second direction and rotating the first roller in the first direction causes the attachment surface of the solid phase biological sample to be brought into compressive contact with the sample receiving surface of the flexible sample strip, the compressive contact causing the flexible sample strip and the solid phase biological sample to be fixedly attached;
a precision guide wheel for positioning a sectioning surface of the solid phase biological sample proximal to a microtomy device; and
a blade of the microtomy device for generating block section including at least a portion of the solid phase biological sample that is fixedly attached to the flexible sample strip as the continuous length of prepared sample strip.

4. The system of claim 3, wherein the solid phase biological sample is an OTC embedded frozen tissue block, the system further comprising:
a cold solution dispenser for applying a cold solution to the sample receiving surface of the flexible sample strip prior to the sample receiving surface of the flexible sample strip being brought into compressive contact with the attachment surface of the solid phase biological sample; and
a cooling unit proximal to an attachment surface of the OTC embedded frozen tissue block, a cooling source emitted by the cooling unit for cooling a portion of the OTC embedded frozen tissue block and the applied cold solution with effect that an attachment strength of the attachment between the flexible sample strip and the solid phase biological sample is improved.

5. The system of claim 3, wherein the solid phase biological sample is a wax embedded tissue block, the system further comprising:
a heating unit proximal to an attachment surface of the wax embedded tissue block, a heating source emitted by the heating unit for melting a portion of the wax embedded tissue block with effect that an attachment strength of the attachment between the flexible sample strip and the solid phase biological sample is improved.

6. The system of claim 1, wherein the prepared biological sample is a liquid phase biological sample.

7. The system of claim 6, wherein the sample preparation assembly comprises:
a syringe controller for dispensing the liquid phase biological sample from a syringe on to a sample receiving surface of the flexible sample strip; and
a smearing plate for smearing the liquid phase biological sample on the sample receiving surface of the flexible sample strip.

8. The system of claim 6, wherein the flexible sample strip includes a plurality of culture wells formed into the sample receiving surface, for receiving the liquid phase biological sample, the liquid phase biological sample including live cells.

9. The system of claim 1, wherein the sample analysis assembly comprises at least one of:
an assaying assembly;
a multi-omics profiling assembly; and
an imaging assembly.

10. The system of claim 1, wherein the flexible sample strip comprises one of:
a thermoplastic material;
a research grade filter paper; or
a metal foil.

11. A method comprising:
dispensing a continuous flexible sample strip via a rotary mechanism;
mounting a prepared biological sample to a sample receiving surface of the flexible sample strip to generate a continuous length of prepared sample strip; and
generating spatial and single-cell multi-omics data corresponding to the mounted biological sample, based on the continuous length of prepared sample strip.

12. The method of claim 11, wherein the prepared biological sample is a solid phase biological sample.

13. The method of claim 12, wherein mounting the prepared biological sample to the sample receiving surface of the flexible sample strip to generate the continuous length of prepared sample strip comprises:
positioning, at a first roller, the sample receiving surface of the flexible sample strip proximal to an attachment surface of the solid phase biological sample, wherein rotating the first roller in a first direction advances the flexible sample strip toward the solid phase biological sample;
rotating a central axial assembly of the solid phase biological sample in a second direction opposite to the first direction, to bring the attachment surface of the solid phase biological sample into compressive contact with the sample receiving surface of the flexible sample strip, the compressive contact causing the flexible sample strip and the solid phase biological sample to be fixedly attached;
positioning a sectioning surface of the solid phase biological sample proximal to a microtomy device using a precision guide wheel; and
while the first roller rotates in the first direction and the central axial assembly of the solid phase biological sample rotates in the second direction, lowering a blade of the microtomy device to contact the sectioning surface of the solid phase biological sample, for generating a serial tissue block section including at least a portion of the solid phase biological sample that is fixedly attached to the flexible sample strip as the continuous length of prepared sample strip.

14. The method of claim 13, wherein the solid phase biological sample is an OTC embedded frozen tissue block, the method further comprising:
prior to bringing the sample receiving surface of the flexible sample strip into compressive contact with the attachment surface of the solid phase biological sample:
applying a cold solution to the sample receiving surface of the flexible sample strip prior to; and
after bringing the sample receiving surface of the flexible sample strip into compressive contact with the attachment surface of the solid phase biological sample:
emitting a cooling source from a cooling unit proximal to an attachment surface of the OTC embedded frozen tissue block, for cooling a portion of the OTC embedded frozen tissue block and the applied cold solution, with effect that an attachment strength of the attachment between the flexible sample strip and the solid phase biological sample is improved.

15. The method of claim 13, wherein the solid phase biological sample is a wax embedded tissue block, the method further comprising:
emitting a heating source from a heating unit proximal to an attachment surface of the wax embedded tissue block, for melting a portion of the wax embedded tissue block with effect that an attachment strength of the attachment between the flexible sample strip and the solid phase biological sample is improved.

16. The method of claim 11, wherein the prepared biological sample is a liquid phase biological sample.

17. The method of claim 16, wherein mounting the prepared biological sample to the sample receiving surface of the flexible sample strip to generate a continuous length of prepared sample strip comprises:
automatically dispensing the liquid phase biological sample from a syringe, on to a sample receiving surface of the flexible sample strip; and
automatically smearing the liquid phase biological sample on the sample receiving surface of the flexible sample strip, using a smearing plate.

18. The method of claim 16, wherein the flexible sample strip includes a plurality of culture wells formed into the sample receiving surface, for receiving the liquid phase biological sample, the liquid phase biological sample including live cells.

19. The method of claim 1, wherein the flexible sample strip comprises one of:
a thermoplastic material;
a research grade filter paper; or
a metal foil.

20. A non-transitory computer-readable medium storing machine-executable instructions which, when executed by one or more processors, cause the processor to perform the method of any one of claims 11 to 19.
